(19) United States
(12) Patent Application Publication
(10) Pub. No.: US 2025/0154925 A1
(43) Pub. Date: May 15, 2025

(54) FUEL PUMP

(71) Applicant: PHINIA DELPHI LUXEMBOURG SARL, Belvaux (LU)

(72) Inventor: Junyi LIANG, Rochester (GB)

(21) Appl. No.: 18/715,499

(22) PCT Filed: Dec. 2, 2022
(86) PCT No.: PCT/EP2022/084292

§ 371 Date: May 31, 2024

(30) Foreign Application Priority Data
Dec. 3, 2021 (GB) 2117546.8

(51) Int. Cl. F02M 55/00; F02M 59/46

(52) U.S. Cl. CPC F02M 55/005; F02M 59/46; F02M 2200/02; F02M 2200/03

(57) ABSTRACT

A pump for a fuel injection system comprises: a main housing; a plunger housing arranged to be coupled to the main housing; and a gasket for arrangement between first and second opposed faces of the main housing and the plunger housing, in assembly, so as to seal a compression chamber defined between the main housing and the plunger housing as the gasket is compressed therebetween. The main housing comprises a valve bore extending to the first face of the main housing for supplying fuel to the compression chamber, and the plunger housing comprises a plunger bore extending to the opposing second face of the plunger housing, defining a central axis of the compression chamber. In assembly, a central axis of the valve bore is radially offset from the central axis of the compression chamber such that a stiffness of the main housing varies circumferentially around the compression chamber.

### FIELD OF THE INVENTION

The invention relates to a pump for use in a fuel delivery system. Aspects of the invention relate to a pump and to a fuel delivery system for an automotive vehicle comprising a pump.

### BACKGROUND TO THE INVENTION

In combustion engine systems, a fuel pump is used to pressurise fuel before it is injected into the cylinders of the engine. Modern compression-ignition engine systems often use a high-pressure fuel pump to feed a pressurised accumulator, known as a common rail, which acts as a reservoir to store the pressurised fuel and feed the individual fuel injectors. In compression-ignition internal engines, the fuel is pressurised to very high levels, typically in excess of 2000 bar. Such high pressures are difficult to manage and engine designers have to pay careful attention to controlling fuel leakages and protecting against damage to parts.

It is against this background that the invention has been devised.

### SUMMARY OF THE INVENTION

According to an aspect of the invention there is provided a pump for a fuel injection system. The pump comprises: a main housing; a plunger housing arranged to be coupled to the main housing; and a gasket for arrangement between respective first and second opposed faces of the main housing and the plunger housing, in assembly, so as to seal a compression chamber defined between the main housing and the plunger housing as the gasket is compressed therebetween (i.e. between the main housing and the plunger housing) under an assembly load. The main housing comprises a valve bore extending to the first face of the main housing for supplying fuel to the compression chamber. The plunger housing comprises a plunger bore extending to the opposing second face of the plunger housing, defining a central axis of the compression chamber. In assembly, a central axis of the valve bore is radially offset from the central axis of the compression chamber such that a stiffness of the main housing varies circumferentially around the compression chamber to define a region of relatively low stiffness proximal to the valve bore and a region of relatively high stiffness distal from the valve bore. The gasket is arranged, when compressed under the assembly load, to reduce the load applied to the low stiffness region of the main housing relative to the load applied to the high stiffness region of the main housing.

In particular, the valve bore extends through the main housing to the first face, thereby reducing the stiffness of the main housing around the valve bore, particularly at the first face of the main housing. In assembly, the central axis of the valve bore is radially offset from the central axis of the compression chamber, and the offset (or misalignment) means that the stiffness of the main housing varies around the circumference of the compression chamber, i.e. varying circumferentially around an area of the main housing encircling the compression chamber in assembly. In particular, the main housing is relatively flexible in a circumferential region that is close, or proximal, to the central axis of the valve bore compared to a relatively stiff circumferential region of the main housing that is relatively distal from the central axis of the valve bore. Advantageously, the gasket is arranged, when compressed under the assembly load, to reduce the load applied to the low stiffness region of the main housing relative to the load applied to the high stiffness region of the main housing, thereby producing more uniform deformation of the main housing under the assembly load. Consequently, the sealing pressure is substantially uniform, mitigating wear and sliding movement between the main housing and the plunger housing.

Optionally, the gasket includes a body having: an opening for the compression chamber; a radially outer portion comprising a base portion extending in a base plane; and a radially inner portion comprising an uneven sealing surface that extends around the opening with a height (or axial distance), relative to the base plane, that varies circumferentially so that, in situ, compression of the sealing surface between the main housing and the plunger housing counteracts the assembly load to reduce the load applied to the low stiffness region of the main housing relative to the load applied to the relatively high stiffness region of the main housing. In this manner, flattening of the sealing surface under the assembly load generates a spring force acting to counteract the assembly load applied to the main housing to a greater extent in the relatively flexible region compared to the relatively stiff region.

For example, the sealing surface may include first and second circumferential sections, where the first circumferential section is being defined at a greater height, relative to the base plane, than the second circumferential section.

Optionally, the first circumferential section is at least 5% higher than the second circumferential section, relative to the base plane. Preferably, the first circumferential section is at least 10% higher than the second circumferential section, relative to the base plane. The first circumferential section may, for example, be less than, or equal to, 20% higher than the second circumferential section, relative to the base plane. In this manner, a suitable spring force is generated corresponding to the relative stiffness of the flexible region of the main housing compared to the stiff region of the main housing.

The first circumferential section may, for example, extend circumferentially through an angle of less than, or equal to, 180 degrees. Preferably, the first circumferential section may extend circumferentially through an angle of less than, or equal to, 160 degrees. The first circumferential section may, for example, extend circumferentially through an angle of greater than, or equal to, 90 degrees. Preferably, the first circumferential section may extend circumferentially through an angle of greater than, or equal to, 120 degrees. In this manner, the span of the first circumferential section may suitably correspond to the size of the valve bore and/or the offset of the central axis of the valve bore from the central axis of the pumping chamber.

Optionally, the first and second circumferential sections of the sealing surface are planar and extend parallel to the base plane. The sealing surface may further includes sloped, and/or curved, sections extending between the first and second circumferential section, for example.

In an example, the base portion of the gasket is arranged on the first face of the main housing, the first circumferential section is arranged relatively proximal to the central axis of the valve bore, aligned with the region of relatively low stiffness, and the second circumferential section is arranged relatively distal from the central axis of the valve bore, aligned with the region of relatively high stiffness. In another example, the base portion of the gasket is arranged on the second face of the plunger housing, the first circumferential section is arranged relatively distal to the central axis of the valve bore, aligned with the region of relatively high stiffness, and the second circumferential section is arranged relatively proximal to the central axis of the valve bore, aligned with the region of relatively high stiffness. In each example, the flattening of the sealing surface under the assembly load therefore acts to reduce the assembly load exerted on the relatively flexible region of the main housing compared to the assembly load exerted on the relatively stiff region of the main housing.

Optionally, the sealing surface is defined by a non-axisymmetric bead arrangement of the gasket. For example, the non-axisymmetric bead arrangement may be formed in the body of the gasket.

Optionally, the first and/or the second face comprises a protruding annular sealing portion that encircles the compression chamber, in assembly. For example, the annular sealing portion may be defined on the first face of the main housing, and the relatively flexible region of the main housing may be defined in a circumferential region of the annular sealing portion that is arranged proximally to the central axis of the valve bore and the relatively stiff region of the main housing may be defined in a circumferential region of the annular sealing portion that is arranged relatively distally from the central axis of the valve bore. Optionally, the gasket may include a step portion, between the radially outer portion and the radially inner portion, providing a step in the height of the gasket, relative to the base plane, for locating the gasket on the annular sealing portion, for example such that the opening of the gasket is aligned concentrically with the central axis of the pumping chamber.

Optionally, the gasket includes an upstanding locating member, received in an opening of the main housing, and/or of the plunger housing, for orienting the sealing surface of the gasket, in situ, with respect to the central axis of the compression chamber.

According to a further aspect of the invention there is provided a gasket of a pump for a fuel injection system. The gasket is arrangeable between a main housing and a plunger housing of the pump so as to seal a compression chamber defined between the main housing and the plunger housing as the gasket is compressed therebetween (i.e. between the main housing and the plunger housing) under an assembly load. The gasket includes a body having: an opening for the compression chamber; a radially outer portion comprising a base portion extending in a base plane; and a radially inner portion comprising an uneven sealing surface that extends around the opening. The sealing surface includes first and second circumferential sections, where the first circumferential section is defined at a greater height, relative to the base plane, than the second circumferential section.

According to another aspect of the invention there is provided a fuel delivery system comprising a pump or a gasket as described in a previous aspect of the invention.

According to yet another aspect of the invention there is provided a pump for a fuel injection system. The pump comprises: a main housing; a plunger housing arranged to be coupled to the main housing; and a gasket for arrangement between respective first and second opposed faces of the main housing and the plunger housing, in assembly, so as to seal a compression chamber defined between the main housing and the plunger housing as the gasket is compressed therebetween under an assembly load. The main housing comprises a valve bore extending to the first face of the main housing for supplying fuel to the compression chamber.

The plunger housing comprises a plunger bore extending to the opposing second face of the plunger housing, defining a central axis of the compression chamber. In assembly, a central axis of the valve bore is radially offset from the central axis of the compression chamber such that a stiffness of the main housing varies circumferentially around the compression chamber to define a region of relatively low stiffness proximal to the valve bore and a region of relatively high stiffness distal from the valve bore. The gasket comprises a body having: an opening for the compression chamber; and an uneven sealing surface that extends around the opening with a height, relative to a base plane of the body/gasket, that varies circumferentially so that, in situ, compression of the sealing surface between the main housing and the plunger housing counteracts the assembly load to reduce the load applied to the low stiffness region of the main housing relative to the load applied to the relatively high stiffness region of the main housing.

It will be appreciated that the various features of each aspect of the invention are equally applicable to, alone or in appropriate combination with, other aspects of the invention.

### BRIEF DESCRIPTION OF THE DRAWINGS

In order that the invention may be more readily understood, preferred non-limiting embodiments thereof will now be described, by way of example only, with reference to the accompanying drawings, in which like features are assigned like reference numbers, and in which:

FIG. 1 is an enlarged cross-sectional view of a compression chamber of a pump for use in understanding the present invention;

FIG. 2 is an enlarged cross-sectional view of a compression chamber of an example pump in accordance with an embodiment of the present invention;

FIG. 3 is a perspective view of an example gasket of the pump shown in FIG. 2;

FIG. 4 is a plan view of the example gasket shown in FIG. 3; and

FIG. 5 is a cross-sectional view of the gasket shown in FIG. 3.

In the following description, directional or relative references such as ‘upper’, ‘lower’, ‘above’ and ‘below’, relate to the orientation of the features as illustrated in the drawings, but such references are not to be considered limiting. The skilled reader will appreciate that pumps in accordance with embodiments of the invention may be oriented differently to the manner depicted in the drawings in practice.

### DETAILED DESCRIPTION OF EMBODIMENTS OF THE INVENTION

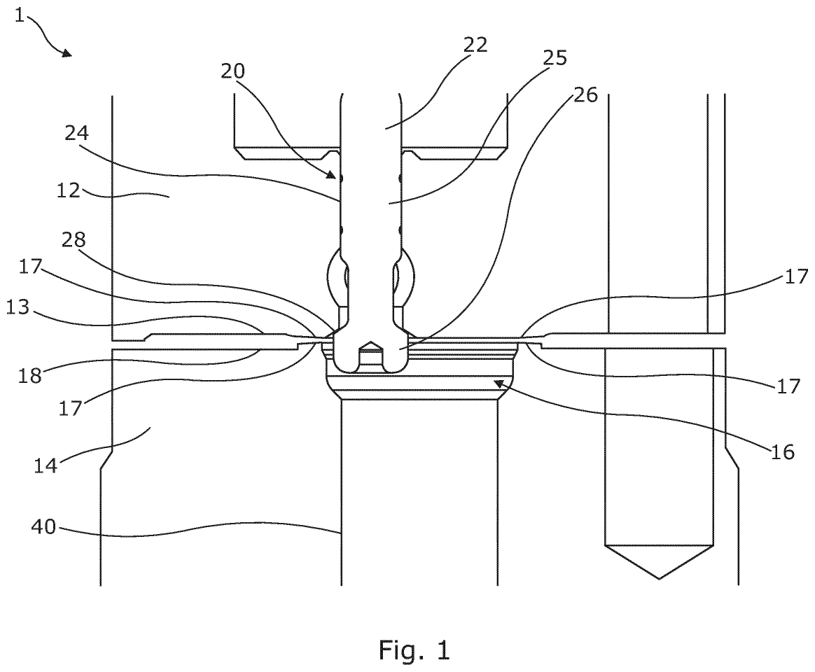

FIG. 1 shows an enlarged cross-sectional view of a portion of an example pump 1 for use in a fuel delivery system. The pump 1 is configured to pressurise fuel for delivery to downstream components of the fuel delivery system, such as a common rail accumulator (not shown) and/or one or more fuel injectors.

The pump 1 generally comprises a main housing 12 and a plunger housing 14. The plunger housing 14 is coupled to the main housing 12, for example by threaded fastening means. In this manner, interfacing surfaces of the main housing 12 and the plunger housing 14 are compressed together by an assembly load, thereby sealing a compression chamber 16 defined between the main housing 12 and the plunger housing 14.

The main housing 12 comprises an inlet valve 20 and an outlet valve (not shown). The inlet valve 20 controls the flow of fuel into the compression chamber 16. The outlet valve (not shown) allows pressurised fuel to be conveyed from the compression chamber 16 to the downstream components of the fuel delivery system.

In more detail, the inlet valve 20 comprises a valve member 22 arranged for reciprocating movement within a valve bore 24 defined by the main housing 12. The valve bore 24 extends though the main housing 12 to a lower face 13 thereof, where the valve bore 24 opens into the compression chamber 16 and defines a valve seat 28. The valve member 22 comprises a valve stem 25 and a valve head 26. In assembly, the valve head 26 projects partially into the compression chamber 16. The diameter of the valve head 26 is sized so as to be larger than the diameter of the valve seat 28 at the lower face 13 of the main housing 12 such that, when the inlet valve 22 is in a closed state, the valve head 26 closes against the valve seat 28 so as to prevent the flow of fuel into the compression chamber 16.

Movement of the inlet valve 22 may, for example, be effected by means of an actuator (not shown), such as a solenoid actuator, and/or a valve spring (not shown). For example, the valve spring may be arranged so as to urge the valve head 26 away from the valve seat 28 toward an open position. When the pressure in the compression chamber 16 rises during a pumping stroke of the pump 1 this produces a force which acts against the valve spring. Closing of the inlet valve 20 can then be effected by energizing the actuator to exert an additional closing force on the valve stem 25. The additional closing force is sufficient to overcome the force of the valve spring such that the valve head 26 closes against the valve seat 28.

The plunger housing 14 comprises an axial plunger bore 40 within which a plunger (not shown) is arranged for reciprocating movement therein. The plunger bore 40 extends though the plunger housing 14 to an upper face 18 thereof, where an opening of the plunger bore 40 is defined. The plunger may be substantially cylindrical in shape and driven in a reciprocating linear motion with a close clearance fit with respect to the adjacent wall of the plunger bore 40. To give an example, a lower end of the plunger (not shown) may be arranged, in use, to contact an engine-driven cam (not shown). Accordingly, a plunger return spring (not shown) may also be disposed around the plunger housing 14, abutting a shoulder of the plunger housing 14 at one end thereof and, at the opposite end thereof, the return spring may abut against a cap, or equivalent shoulder feature, affixed to the lower end of the plunger, so as to urge the lower end of the plunger against the engine-driven cam.

The plunger bore 40 defines a central axis of the pumping chamber 16 in assembly, which extends from the plunger bore 40 to a corresponding area on the lower face 13 of the main housing 12, encompassing the respective openings of the inlet and outlet valves 20.

Accordingly, in use, fuel is admitted into the compression cylinder 16 through the inlet valve 20 and the plunger is driven upwards during a pumping stroke of the pump 1 to reduce the volume of the compression chamber 16 and thereby to pressurise the fuel disposed therein. Accordingly, the upper end of the plunger features an end face or compression surface for pressuring the fuel in the compression chamber 16. When the pressure of the fuel in the compression chamber 16 reaches a threshold value it is sufficient to cause the outlet valve (not shown) in the main housing 12 to open such that the pressurised fuel can be conveyed downstream, for example to the common rail accumulator.

In order to achieve the desired pressure in the compression chamber 16 during the pumping stroke, the compression chamber 16 must be substantially sealed so as to prevent or substantially eliminate egress of fuel from the compression chamber 16 other than via the outlet valve (not shown).

To provide sufficient sealing, the lower face 13 of the main housing 12 and/or the upper face 18 of the plunger housing 14 are therefore complementary to one another and may feature complementary annular sealing portions 17, as shown in FIG. 1. The annular sealing portions 17 encircle the compression chamber 16 defined between the main housing 12 and the plunger housing 14, extending circumferentially around the opening of the plunger bore 40 and the corresponding area on the lower face 13 of the main housing 12.

To provide effective sealing, the annular sealing portions 17 may feature a knife-edge design, as shown in FIG. 1, according to which the cross sections of the annular sealing portions 17 are tapered so as to define a relatively narrow annular contact surfaces at their extremities. When the plunger housing 14 is attached to the main housing 12, the tapered shape of the annular sealing portions 17 concentrates the contact force of the plunger housing 14 against the main housing 12 over a small surface area, forming a secure seal therebetween.

However, an issue with pumps of the design described above is that the valve bore 24 has the effect of reducing the stiffness of the surrounding region of the main housing 12, particularly toward the lower face 13 thereof. In a typical pump, the valve bore is arranged coaxially with the pumping chamber, so that any detrimental effects of the valve bore on the stiffness of the main housing are not too problematic.

However, in the example pump 1, a central axis of the valve bore 24 is radially offset from, or eccentric to, the central axis of the compression chamber 16, as shown in FIG. 1. Consequently, the stiffness of the main housing 12 varies circumferentially in the region encircling the compression chamber 16, defining a relatively flexible region proximal to the valve bore 24, and a relatively stiff region distal from the valve bore 24. In particular, considering an annular region of the main housing 12 that is concentric with and encircles the compression chamber 16, the relatively flexible region may be defined in a circumferential section that is proximal to the valve bore 24 due to the radial offset of the valve bore 24, and the relatively stiff region may be defined in another circumferential section that is distal from the valve bore 24, i.e. in a section arranged at a greater radial distance from the central axis of the valve bore 24. For example, the relatively flexible region and the relatively stiff region may be arranged on diametrically opposed portions of the annular sealing portion 17 of the main housing 12, aligned with the direction of the radial offset of the valve bore 24 from the central axis of the pumping chamber 16.

Consequently, when subjected to the assembly loads that hold the main housing 12 and the plunger housing 14 together, there is relatively little resistance to deformation at the flexible region of the main housing 12, leading to non-uniform deformation of the main housing 12 and the plunger housing 14 around the compression chamber 16.

As a further consequence, the sealing pressure, i.e. the pressure on the interfacing surfaces 13, 18 of the main housing 12 and the plunger housing 14, also varies circumferentially around the compression chamber 16, which compromises the seal of the compression chamber 16 and promotes wear and sliding between the main housing 12 and the plunger housing 14. Radial dilation of the compression chamber 16 is also increased and radial movement of the inlet valve 22 is more pronounced, leading to sliding and wear on the valve head 28.

The degradation due to wear at the interface of the main housing 12 and the plunger housing 14 is further exacerbated in examples where the lower face 13 of the main housing 12, and/or the upper face 18 of the plunger housing 14, feature annular sealing portions with a knife-edge design as described above. In such examples, the small surface area provided for effective sealing generates a significant contact stress at the interface. Consequently, relative sliding of the main housing 12 and/or the plunger housing 14, during the pumping stroke, generates significant wear, which can lead to damage and increased leakage from the compression chamber 16, ultimately impairing the operation of the pump 1.

To mitigate these issues, a pump in accordance with embodiments of the present invention includes a gasket arranged at the interface between the opposing surfaces of the main housing and the plunger housing. Advantageously, when compressed under the assembly load, the gasket is configured to reduce the load applied to the low stiffness region of the main housing relative to the load applied to the high stiffness region of the main housing.

For example, the gasket may include a non-axisymmetric bead arrangement, which defines an uneven sealing surface that varies around its circumference in height, or axial distance, relative to a base plane of the gasket so that, in situ, compression of the sealing surface between the main housing and the plunger housing compensates for variations in the stiffness of the underlying (i.e. axially adjacent) regions of the main housing. In particular, flattening the sealing surface between the main housing and the plunger housing generates a spring force that acts to counteract the assembly loads to a greater extent in the region of relatively low stiffness than in the region of relatively high stiffness, thereby producing more uniform deformation of the main housing in the area encircling the pumping chamber.

Consequently, uneven sealing pressures, and friction, at the interfacing surfaces may be reduced, leading to an increased load capacity and/or fatigue life of the pump.

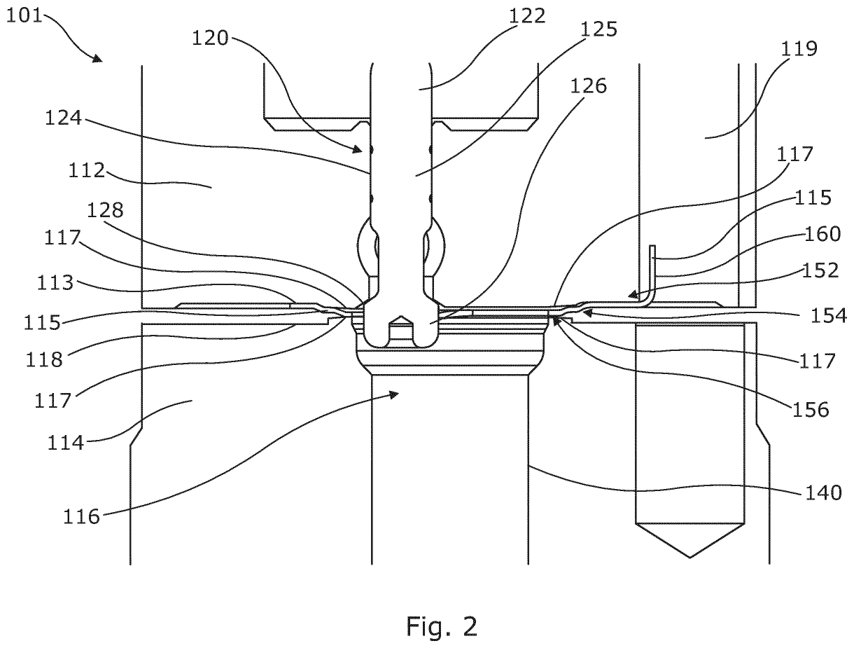

An exemplary pump 101 in accordance with an embodiment of the invention is provided in FIGS. 2 to 5, which shall now be described in more detail. It should be noted that, for the sake of simplicity, counterpart features of the example are assigned similar reference numbers to those used previously, but incremented by 100 in the following example.

FIG. 2 shows an enlarged cross-sectional view of a portion of an exemplary pump 101 for use in a fuel delivery system. The pump 101 is configured to pressurise fuel for delivery to downstream components of the fuel delivery system, such as a common rail accumulator (not shown) and/or one or more fuel injectors.

The pump 101 generally comprises a main housing 112, a plunger housing 114, and a gasket 115. The plunger housing 114 is coupled to the main housing 112, with the gasket 115 arranged between the plunger housing 114 and the main housing 112. In this manner, the gasket 115 is compressed by the assembly loads between the interfacing surfaces of the main housing 112 and the plunger housing 114 so as to seal a compression chamber 116 defined therebetween.

The main housing 112 comprises an inlet valve 120 and an outlet valve (not shown). The inlet valve 120 controls the flow of fuel into the compression chamber 116. The outlet valve (not shown) allows pressurised fuel to be conveyed from the compression chamber 116 to the downstream components of the fuel delivery system.

In more detail, the inlet valve 120 comprises a valve member 122 arranged for reciprocating movement within a valve bore 124 defined by the main housing 112. The valve bore 124 extends though the main housing 112 to a lower face 113 thereof, where the valve bore 124 opens into the compression chamber 116 and defines a valve seat 128. The valve member 122 comprises a valve stem 125 and a valve head 126. In assembly, the valve head 126 projects partially into the compression chamber 116. The diameter of the valve head 126 is sized so as to be larger than the diameter of the valve seat 128 at the lower face 113 of the main housing 112 such that, when the inlet valve 122 is in a closed state, the valve head 126 closes against the valve seat 128 so as to prevent the flow of fuel into the compression chamber 116.

Movement of the inlet valve 122 may, for example, be effected by means of an actuator (not shown), such as a solenoid actuator, and/or a valve spring (not shown). For example, the valve spring may be arranged so as to urge the valve head 126 away from the valve seat 128 toward an open position. When the pressure in the compression chamber 116 rises during a pumping stroke of the pump 101 this produces a force which acts against the valve spring. Closing of the inlet valve 120 can then be effected by energizing the actuator to exert an additional closing force on the valve stem 125. In particular, the additional closing force is sufficient to overcome the force of the valve spring such that the valve head 126 closes against the valve seat 128.

The plunger housing 114 comprises an axial plunger bore 140 within which a plunger (not shown) is arranged for reciprocating movement therein. The plunger bore 140 extends though the plunger housing 114 to an upper face 118 thereof, where an opening of the plunger bore 124 is defined. The plunger may be substantially cylindrical in shape and driven in a reciprocating linear motion with a close clearance fit with respect to the adjacent wall of the plunger bore 140. To give an example, a lower end of the plunger may be arranged, in use, to be in contact with an engine-driven cam (not shown). Accordingly, a plunger return spring (not shown) may also be disposed around the plunger housing 114, abutting a shoulder of the plunger housing 114 at one end thereof and, at the opposite end thereof, the plunger return spring may abut against a cap, or equivalent shoulder feature, affixed to the lower end of the plunger, so as to urge the lower end of the plunger against the engine-driven cam.

The plunger bore 140 defines a central axis of the pumping chamber 116 in assembly, which extends from the plunger bore 140, through the intermediate gasket 115, to a corresponding area on the lower face 113 of the main housing 112, encompassing the respective openings for the inlet and outlet valves 120.

Accordingly, in use, fuel is admitted into the compression cylinder 116 through the inlet valve 120 and the plunger is driven upwards during a pumping stroke of the pump 101 to reduce the volume of the compression chamber 116 and thereby to pressurise the fuel disposed therein. Accordingly, the upper end of the plunger features an end face or compression surface for pressuring the fuel in the compression chamber 116. When the pressure of the fuel in the compression chamber 116 reaches a threshold value it is sufficient to cause the outlet valve (not shown) in the main housing 112 to open such that the pressurised fuel can be conveyed downstream, for example to the common rail accumulator.

In order to achieve the desired pressure in the compression chamber 116 during a pumping stroke, the compression chamber 116 must be substantially sealed so as to prevent or substantially eliminate egress of fuel from the compression chamber 116 other than via the outlet valve (not shown). To promote such sealing, the lower face 113 of the main housing 112 and/or the upper face 118 of the plunger housing 114 are complementary to one another and may feature complementary annular sealing portions 117, as shown in FIG. 2.

The annular sealing portions 117 encircle the compression chamber 116 defined between the main housing 112 and the plunger housing 114, extending circumferentially around the opening of the plunger bore 140 and the corresponding area on the lower face 113 of the main housing 112, and protruding therefrom. As shown in FIG. 2, the annular sealing portions 117 may feature a knife-edge design to promote an effective seal, whereby the cross sections of the annular seal portions 117 are tapered so as to define a relatively narrow annular contact surfaces at their extremities. Accordingly, the tapered shape of the annular sealing portions 117 concentrate the contact forces of the plunger housing 14 and the main housing 112 over a small surface area of the gasket 115, forming a secure seal at the interfacing surfaces.

However, the valve bore 124 has the effect of reducing the stiffness of the surrounding region of the main housing 112 and a central axis of the valve bore 124 is radially offset from, or eccentric to, the central axis of the compression chamber 116. Consequently, the stiffness of the main housing 112 varies circumferentially in the region encircling the compression chamber 116, defining a region of relatively low stiffness (i.e. a flexible region) proximal to the valve bore 124, and a region of relatively high stiffness (i.e. a stiff region) distal from the valve bore 124. In particular, considering an annular region of the main housing 112 that is concentric with and encircles the compression chamber 116, the relatively flexible region may be defined in a circumferential section that is proximal to the valve bore 124 (due to the radial offset of the valve bore 124), and the relatively stiff region may be defined in another circumferential section that is distal from the valve bore 124, i.e. in a section arranged at a greater radial distance from the central axis of the valve bore 124. To give an example, the relatively flexible region and the relatively stiff region may be arranged on diametrically opposed portions of the annular sealing portion 117 of the main housing 112, aligned with the direction of the radial offset of the valve bore 124 from the central axis of the pumping chamber 116. Consequently, when subjected to the assembly loads that hold the pump 101 together, there is less resistance to deformation at the relatively flexible region than at the relatively stiff region.

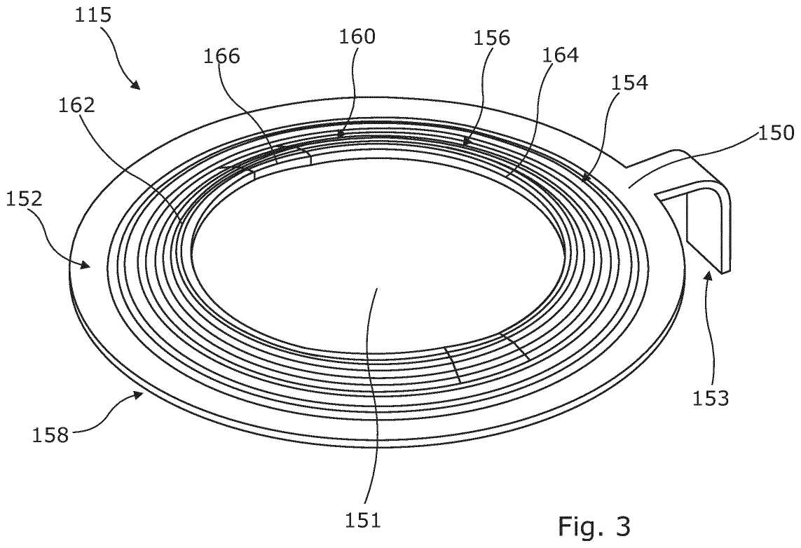

In embodiments of the pump 101 in accordance with the present invention, the gasket 115 is advantageously designed to counteract the effects of such areas of reduced stiffness and thereby to mitigate relative movement of the plunger housing 114 during the pumping stroke, as shall be described in more detail with additional reference to FIGS. 3 to 5.

FIG. 3 shows an exemplary gasket 115 in accordance with an embodiment of the invention. The gasket 115 is designed for arrangement between the respective upper and lower faces 113, 118 of the main housing 112 and the plunger housing 114, which are compressed together in assembly so as to seal the compression chamber 16 defined therebetween.

In the example shown in FIG. 3, the gasket 115 is designed for arrangement on the lower surface 113 of the main housing 112 and includes an annular body 150 corresponding to the lower surface 113 of the main housing 112, and a central opening 151 corresponding to the opening of the plunger bore 140.

The gasket 115 also includes an upstanding locating member 153, such as an axially extending foot, that extends away from the annular body 150 for orienting the gasket 115 in situ by engaging a corresponding opening of the main housing 112, and/or of the plunger housing 114. For example, as shown in FIG. 2, the locating member 153 may be received in an opening 119 used to align the main housing 112 and the plunger housing 114 during the assembly process. In this manner, the locating member 153 serves to orient the gasket 115 in situ so as to ensure that the spring force of the gasket 115 counteracts the effects of the uneven stiffness in the region of the main housing 112 encircling the compression chamber 116, as shall be described in more detail below.

The body 150 of the gasket 115 features a concentric arrangement of a base portion 152, a step portion 154, and a non-axisymmetric bead arrangement 156. The base portion 152 therefore forms a radially outer portion of the gasket 115, taking the form of a substantially planar ring in this example, which is complementary to a corresponding mounting area on the lower surface 113 of the main housing 112. As best shown in FIG. 5, the base portion 152 therefore extends circumferentially and radially in a plane that shall be referred to as a base plane 158 in the following description.

The step portion 154 extends radially inward from the base portion 152 and is designed to accommodate the protrusion of the annular sealing portion 117 from the lower surface 113 of the main housing 112. The step portion 154 therefore includes an axial step, or increment in the height of the gasket 115, relative to the base plane 158, for locating the gasket 115 on the annular sealing portion 117. The axial step may be achieved by a sloped, or otherwise curved, region that extends at an inclined angle to the base plane 158. The step portion 154 also includes a further region, radially inward of the sloped/curved region, configured to rest on the surface of the annular sealing portion 117. In this manner, the step portion 154 effectively defines an inner tier of the gasket 115, which extends at a greater height, or axial distance, from the base plane 158 to accommodate the raised surface of the annular sealing portion 117. Since the step portion 154 encloses the raised surface of the annular sealing portion 117, the step portion 154 also serves to locate the gasket 115 between the main housing 112 and the plunger housing 114 such that the opening 151 of the gasket 115 is substantially aligned with the opening of the plunger bore 140.

The non-axisymmetric bead arrangement 156 extends radially inward from the step portion 154 to the opening 151, and extends axially away from the base plane 158, to define an uneven sealing surface 160 around the opening 151 of the gasket 115. When the sealing surface 160 is compressed between the main housing 112 and the plunger housing 114, in situ, the uneven sealing surface 160 is substantially flattened. The deformation required to flatten the sealing surface 160 compensates for the variable stiffness of the underlying regions of the main housing 112. In particular, flattening the sealing surface 160 between the main housing 112 and the plunger housing 114 generates a spring force that acts to reduce the assembly loads at the relatively flexible region of the main housing 112, thereby producing more uniform deformation of the main housing 112 around the pumping chamber 116. For example, the compressed gasket 115 may generate a spring force having a larger axial component in an area underlying the relatively flexible region of the main housing 112, than the spring force produced in an area underlying the relatively stiff region of the main housing 112. Consequently, the deformation of the main housing 112 is reduced across that relatively flexible region, producing a more uniform sealing pressure around the circumference of the compression chamber 116.

To generate a suitable spring force, the uneven sealing surface 160 defined by the non-axisymmetric bead arrangement 156 therefore has a height, or axial distance, relative to the base plane 158, that varies around the circumference of the sealing surface 160 in a manner corresponding to the variation in the stiffness of the main housing 112 around the pumping chamber 116. The skilled person shall appreciate that this may be embodied in various suitable forms.

For example, around the circumference of the sealing surface 160, the height of the sealing surface 160 may vary between a maximum height and a minimum height relative to the base plane 158. A high point, or peak, of the sealing surface 160 may therefore be diametrically opposed to a low point, or trough, of the sealing surface 160 and, in situ, the locating member 153 may therefore orient the gasket 115 such that the high point lies in the direction of the central axis of the valve bore 124 relative to the central axis of the plunger bore 140. In which case, the low point may therefore lie in an opposing direction relative to the central axis of the plunger bore 140. In this manner, the high point may underlie the relatively flexible region of the main housing 112 and the low point may underlie the relatively stiff region of the main housing 112, such as the respective diametrically opposed portions of the annular sealing portion 117. Here it shall be appreciated that the term underlie is made with reference to the orientation shown in FIG. 2 and where high point or the low point underlies a respective region of the main housing 112 it shall be appreciated that the high/low points may otherwise be considered to be arranged axially adjacent to the respective regions of the main housing 112.

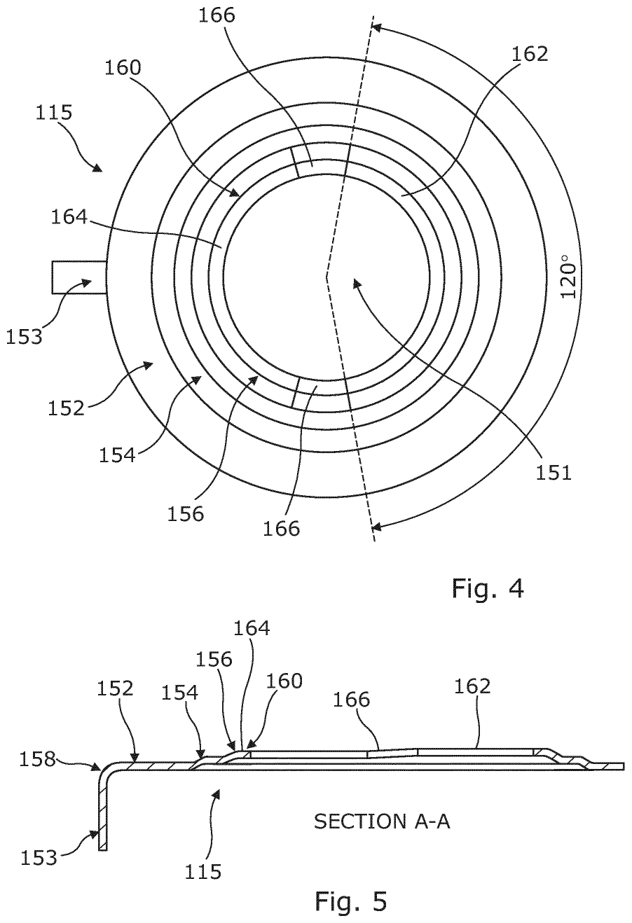

In the present example, the arrangement of the sealing surface 160 is best shown with reference to FIGS. 4 and 5. In particular, as shown in FIGS. 4 and 5, the uneven sealing surface 160 may include a first circumferential section 162 and a second circumferential section 164, spanning opposing circumferential portions of the sealing surface 160. The first and second circumferential sections 162, 164 are substantially planar and connected by sloped, and/or curved, sections 166 of the surface 160, which are inclined to the base plane 158 such that the first and second circumferential sections 162, 164 are arranged at different heights, relative to the base plane 158. For example, the first circumferential section 162 may be at least 5% higher than the second circumferential section 164 and, preferably, at least 10% higher than the second circumferential section 164. Generally, the first circumferential section 162 may be up to 20% higher than the second circumferential section 164, relative to the base plane 158.

In this example, the first circumferential section 162 extends circumferentially through an angle of approximately 120 degrees, which corresponds to the span of the relatively flexible region of the main housing 112, and is suitable for mitigating the effects of the variable stiffness. However, in other examples, the first circumferential section 162 may extend circumferentially through an angle of less than, or equal to, 180 degrees, preferably, less than, or equal to, 160 degrees, according to the offset of the valve bore 124 and the resulting effects on the stiffness of the main housing 112. In general though, the first circumferential section 162 may extend circumferentially through an angle of at least 90 degrees, for example.

Referring again to FIG. 2, in assembly, the gasket 115 is positioned between the lower face 113 of the main housing 112 and the upper face 114 of the plunge housing 114, such that the base portion 152 of the gasket 115 rests on the mounting area of the lower face 113. The step portion 154 of the gasket 115 is received on the annular sealing portion 117, and thereby locates the gasket 115 such that the opening 151 of the gasket 115 is coaxial with the plunger bore 140. The locating member 153 is received in the opening 119 of the main housing 112, and thereby orients the gasket 115 such that the first circumferential section 162 of the sealing surface 160 lies in the direction of the offset of the central axis of the valve bore 124 from the central axis of the pumping chamber 116. The second circumferential section 164 therefore lies in an opposing direction from the central axis of the pumping chamber 116. In this manner, the first circumferential section 162 is arranged proximally to the central axis of the valve bore 124, underlying the relatively flexible region of the main housing 112, and the second circumferential section 164 is arranged distally from the central axis of the valve bore 124, underlying the relatively stiff region of the main housing 114. In other words, a radial distance from the central axis of the valve bore 124 to the first circumferential section 162 is smaller than a radial distance from the central axis of the valve bore 124 to the second circumferential section 164.

Accordingly, when the sealing surface 160 is compressed, and substantially flattened, in situ, the first circumferential section 162 is displaced to a greater extent than the second circumferential section 164, which generates a corresponding spring force acting to counteract the assembly loads. In particular, as the first circumferential section 162 is arranged proximal to the central axis of the valve bore 162, the spring force generated by the compression therefore acts to counteract the assembly loads to a greater extent at the relatively flexible region of the main housing 112 than at the relatively stiff region of the main housing 112. This has the effect of producing more uniform deformation of the main housing 112.

Accordingly, the sealing pressure, i.e. the pressure on the annular sealing portions 117 of the main housing 112 and the plunger housing 114, and the gasket 115, is substantially uniform, mitigating wear and sliding movement between the main housing 112 and the plunger housing 114. Additionally, radial dilation of the compression chamber 116 is reduced and radial movement of the inlet valve 122 is mitigated because of the uniform deformation, leading to reduced sliding and wear on the valve head 128.

It is envisaged that the pump 101 of the present invention will therefore provide a higher load capacity, and fatigue life, allowing for higher pumping loads and increased fuel pressures.

It will be appreciated by a person skilled in the art that the invention could be modified to take many alternative forms to that described herein, without departing from the scope of the appended claims.

For example, in an alternative embodiment, it shall be appreciated that the inlet valve 120 may be a passive valve such that the actuator may be omitted. In this case, the valve spring may be arranged so as to urge the valve member toward a closed state, i.e. such that the valve head is biased toward the valve seat. With such an arrangement, the spring constant of the valve spring can be selected such that opening of the inlet valve against the force of the valve spring is effected by means of a vacuum created within the plunger bore as the plunger makes its return stroke. As the pressure differential across the valve head increases it will cause the valve head to lift away from the valve seat against the force of the valve spring thereby allowing fuel to flow into the compression chamber. This, in turn, reduces the difference in the pressure above and below the valve head until the pressure differential is no longer sufficient to hold the inlet valve open against the force of the valve spring.

Furthermore, in the example shown in FIG. 3, the gasket 115 is designed for arrangement on the lower surface 113 of the main housing 112 and includes an annular body 150 corresponding to the lower surface 113 of the main housing 112. However, in other examples, it shall be appreciated that the body 150 of the gasket 115 may take other suitable shapes corresponding to that surface 113.

Moreover, in other examples, the gasket 115 may instead be designed for arrangement on the upper surface 118 of the plunger housing 114. In which case, it shall be appreciated that the base portion 152 of the gasket 115 may instead correspond to the upper face 118 of the plunger housing 114 and the sealing surface 160 may extend away from the base plane 158 defined by the base portion 152 to define a high point distal from the central axis of the valve bore 124, and a low point proximal to the central axis of the valve bore 124 instead. For example, the first circumferential section 162 may be arranged to underlie the stiff region of the main housing 112 instead and, accordingly, the lower second circumferential section 164 may be arranged in alignment with the flexible region of the main housing 112 In this manner, when the gasket 115 is compressed under the assembly load, the spring force generated by the gasket 115 would again act to reduce the lad applied to the flexible region of the main housing 112 compared to the load applied to the stiff region of the main housing 112. In this example, it shall be appreciated that circumferential span of each of the first and second circumferential sections 162, 164 may also be adapted accordingly.

Furthermore, in the example shown in FIG. 3, the gasket 115 includes the step portion 154 for accommodating the annular sealing portion 117 on the lower face 113 of the main housing 112. However, in other examples, it shall be appreciated that the lower face 113 of the main housing 112 may be substantially planar, without an annular sealing portion 117, and for such pump designs, the base portion 152 of the gasket 115 may extend radially inward to the non-axisymmetric bead arrangement 156, such that the gasket 115 does not include a step portion, per se.

Additionally, as described above, the bead arrangement 156 of the gasket 115 is non-axisymmetric, extending circumferentially around the opening 151 of the gasket 115, with a varying axial distance from the base plane 158 that defines the uneven sealing surface 160. However, as shown in the example of FIG. 3, the bead arrangement 156 of the gasket 115 may be symmetrical, extending in a circular path around the opening 151, with a line of symmetry extending along a line that bisects the first and second circumferential sections 162, 164. In other examples, the bead arrangement 156 may be asymmetric.

Furthermore, in the example shown in FIG. 3, the gasket 115 includes the upstanding locating member 153 for insertion into a corresponding opening of the main housing 112, and/or of the plunger housing 114. However, it shall be appreciated that, in other examples, the upstanding locating member 153 may extend, additionally, or alternatively, in an opposing axial direction to the base plane 158, and the locating member 153 may therefore be received in a corresponding opening of the plunger housing 114.

It shall be also appreciated that, in the examples described above, the gasket 115 may, for example, be formed from a suitable gasket material for high pressure pumps with a surface finish for reducing wear. To give an example, the gasket 115 may be formed of stainless steel, such as EN 10088-2 X10 CrNi 18-8+2H.

### REFERENCES USED

1—pump
12—main housing
13—first face (of main housing)
14—plunger housing
16—compression chamber
17—annular seal portion
18—second face (of plunger housing)
20—inlet valve
22—(inlet) valve member
24—valve bore
25—valve stem
26—valve head
28—valve seat
40—plunger bore
101—pump
112—main housing
113—first face (of main housing)
114—plunger housing
115—gasket
116—compression chamber
117—annular sealing portion
118—second face (of plunger housing)
119—opening (for threaded fastening means)
120—inlet valve
122—(inlet) valve member
124—valve bore
125—valve stem
126—valve head
128—valve seat
140—plunger bore
150—body of gasket
151—opening of gasket
152—base portion (of gasket)
153—upstanding locating member (of gasket)
154—step portion (of gasket)
156—non-axisymmetric bead arrangement (of gasket)
158—base plane (of gasket)
160—uneven sealing surface (of gasket)
162—first circumferential section (of sealing surface)
164—second circumferential section (of sealing surface)
166—curved and/or sloped circumferential sections (of sealing surface)

1. A pump for a fuel injection system, the pump comprising:
a main housing;
a plunger housing arranged to be coupled to the main housing; and
a gasket for arrangement between respective first and second opposed faces of the main housing and the plunger housing, in assembly, so as to seal a compression chamber defined between the main housing and the plunger housing as the gasket is compressed therebetween under an assembly load,
wherein the main housing comprises a valve bore extending to the first face of the main housing for supplying fuel to the compression chamber, and the plunger housing comprises a plunger bore extending to the opposing second face of the plunger housing, defining a central axis of the compression chamber, and
wherein, in assembly, a central axis of the valve bore is radially offset from the central axis of the compression chamber such that a stiffness of the main housing varies circumferentially around the compression chamber to define a region of relatively low stiffness proximal to the valve bore and a region of relatively high stiffness distal from the valve bore; and
wherein the gasket comprises a body having:
an opening for the compression chamber; and
an uneven sealing surface that extends around the opening with a height, relative to a base plane of the gasket, that varies circumferentially so that, in situ, compression of the sealing surface between the main housing and the plunger housing counteracts the assembly load to reduce the load applied to the low stiffness region of the main housing relative to the load applied to the relatively high stiffness region of the main housing.

2. A pump as claimed in claim 1, wherein the body further includes:
a radially outer portion comprising abase portion extending in the base plane; and
a radially inner portion comprising the uneven sealing surface.

3. A pump as claimed in claim 2, wherein the sealing surface includes first and second circumferential sections, the first circumferential section being defined at a greater height, relative to the base plane, than the second circumferential section.

4. A pump according to claim 3, wherein the first circumferential section is at least 5% higher than the second circumferential section, relative to the base.

5. A pump according to claim 3, wherein the first circumferential section is less than, or equal to, 20% higher than the second circumferential section, relative to the base plane.

6. A pump according to claim 3, wherein the first circumferential section extends circumferentially through an angle of less than, or equal to, 180 degrees and, preferably, the first circumferential section extends circumferentially through an angle of less than, or equal to, 160 degrees.

7. A pump according to claim 3, wherein the first circumferential section extends circumferentially through an angle of greater than, or equal to, 90 degrees.

8. A pump according to claim 3, wherein the first and second circumferential sections of the sealing surface are planar and extend parallel to the base plane, and wherein the sealing surface further includes sloped, and/or curved, sections extending between the first and second circumferential sections.

9. A pump according to claim 3, wherein the base portion of the gasket is arranged on the first face of the main housing, the first circumferential section is arranged relatively proximal to the central axis of the valve bore, aligned with the region of relatively low stiffness, and the second circumferential section is arranged relatively distal from the central axis of the valve bore, aligned with the region of relatively high stiffness.

10. A pump according to claim 3, wherein the base portion of the gasket is arranged on the second face of the plunger housing, the first circumferential section is arranged relatively distal to the central axis of the valve bore, aligned with the region of relatively high stiffness, and the second circumferential section is arranged relatively proximal to the central axis of the valve bore, aligned with the region of relatively high stiffness.

11. A pump according to claim 2, wherein the sealing surface is defined by a non-axisymmetric bead arrangement of the gasket.

12. A pump according to claim 11, wherein the non-axisymmetric bead arrangement is formed in the body of the gasket.

13. A pump according to claim 2, wherein the first and/or the second face comprises a protruding annular sealing portion that encircles the compression chamber, in assembly, and wherein the gasket includes a step portion, between the radially outer portion and the radially inner portion, providing a step in the height of the gasket, relative to the base plane, for locating the gasket on the annular sealing portion such that the opening of the gasket is aligned concentrically with the central axis of the pumping chamber.

14. A pump according to claim 2, wherein the gasket includes an upstanding locating member received in an opening of the main housing, and/or of the plunger housing, for orienting the sealing surface of the gasket, in situ, with respect to the central axis of the compression chamber.

15. A fuel delivery system comprising a pump according to claim 1.
